(19) United States
(12) Patent Application Publication
(10) Pub. No.: US 2020/0095048 A1
(43) Pub. Date: Mar. 26, 2020

(54) CONTAINER FOR METALLIC SCRAP, PARTICULARLY FOR SAFELY STORING AND TRANSPORTING SCRAP OF TITANIUM AND ALLOYS THEREOF

(71) Applicant: SPECIAL RARE METALS SA, Cadro (CH)

(72) Inventor: Antonio TOSI, Pregassona (CH)

(21) Appl. No.: 16/469,842

(22) PCT Filed: Dec. 20, 2016
(86) PCT No.: PCT/IB2016/057821

§ 371 Date: Jun. 14, 2019

(51) Int. Cl. B65D 81/20; B65D 19/08; B65D 19/38; B65D 77/04; B01D 29/23

(52) U.S. Cl. CPC B65D 81/2038; B01D 2201/40; B65D 19/38; B65D 77/0466; B01D 29/23; B65D 2519/00024; B65D 2519/00059; B65D 2519/00164; B65D 2519/00199; B65D 2519/00273; B65D 2519/00323; B65D 2519/00338; B65D 2519/00621; B65D 2519/00666; B65D 2519/00711; B01D 2201/204; B65D 19/08

(57) ABSTRACT

A container for metallic scrap, particularly for safely storing and transporting scrap of titanium and alloys thereof, includes an external container body and a lid. The external container body can be closed hermetically using the lid, defining and delimiting a vacuum chamber. The container includes a vacuum pump, which is adapted to create vacuum in the vacuum chamber.

### TECHNICAL FIELD

The present disclosure relates to a container for metallic scrap, particularly but not exclusively useful and practical in the field of safe storage and transport of scrap of titanium (symbol Ti) and alloys thereof This scrap comprises for example titanium chips produced by mechanical machining of the metal with machine tools.

In the present description, the term “transport” is understood to reference transport in general and therefore comprises ground transport, for example by means of heavy goods vehicles or freight trains, air transport, for example by means of transport aircraft or cargo aircraft, and maritime transport, for example by means of cargo ships or container ships.

### BACKGROUND

Like other metals, the machining of titanium produces waste material (scrap), for example in the form of chips.

Since titanium is an expensive metal, its scrap is typically recovered after machining to be then reused for other new purposes after appropriate treatments.

In any case, although it is typically recovered and reused, this titanium scrap is commonly classified as waste and, within waste management in general, there are various national and international standards (for example at the European level) according to which the producer of the waste must identify its type by means of a code, for example of the numeric type. This code is associated with the waste prior to its storage and transport.

By means of standard classification systems, such as for example the European Waste Catalogue (EWC), it is then possible to identify the type of waste for any disposal or recovery starting from said code.

Currently, scrap of titanium and also of other metals is stored and transported by using bins, i.e., large metal containers, commonly used in the mechanical industry for the management of machining waste.

However, these solutions of the known type are not free from drawbacks, which include the fact that the known containers used for storage and transport of titanium scrap offer no prevention and/or protection against the risk of fire or even explosion. This risk is due mainly to the high reactivity in air when hot that characterizes so-called reactive metals in general and titanium in particular.

Titanium in fact burns if it is heated in air, due to its high affinity for oxygen, nitrogen, hydrogen or mixtures thereof Titanium is also the only element that burns in a pure nitrogen atmosphere.

Moreover, this risk of fire or explosion is further amplified by the fact that titanium scrap is typically in the form of chips, i.e., in a form that increases considerably the surface of the metal in contact with air.

Titanium is one of the most dangerous elements in case of combustion, since there are no known effective methods for extinguishing a fire of titanium scrap. Titanium scrap fires in fact cannot be extinguished with known firefighting products. Probably, the use of a mixture of siliceous sand and sea salt might help to extinguish a titanium scrap fire.

### SUMMARY

The aim of the present disclosure is to overcome the limitations of the background art cited above, devising a container for metallic scrap, particularly for safely storing and transporting scrap of titanium and alloys thereof, which allows correct storage of scrap of a reactive metal, maximizing the level of safety in the subsequent step of transport thereof, mainly ground transport but also air transport and sea transport.

Within the scope of this aim, the present disclosure provides a container for metallic scrap, particularly for safely storing and transporting scrap of titanium and alloys thereof, which prevents the triggering of combustion, which might cause a fire or even an explosion of the reactive material stored and transported inside it.

The disclosure also provides a container for metallic scrap, particularly for safely storing and transporting scrap of titanium and alloys thereof, that allows to minimize the exposure to air of the reactive metal, consequently reducing the contact of the reactive metal with the gases for which it has affinity, such as for example oxygen, nitrogen, hydrogen or mixtures thereof.

The present disclosure further provides a container for metallic scrap, particularly for safely storing and transporting scrap of titanium and alloys thereof, that allows to facilitate the operations for storing the reactive metal and to speed up the operations for loading said container before its transport.

The present disclosure provides a container for metallic scrap, particularly for safely storing and transporting scrap of titanium and alloys thereof, that allows good maneuverability, ensuring the integrity of all of its parts and protecting them from any impacts of various kinds that might compromise its operation.

The present disclosure also provides a container for metallic scrap, particularly for safely storing and transporting scrap of titanium and alloys thereof, that is highly reliable, relatively simple to provide, and at competitive costs if compared with the background art.

This aim, as well as these and other advantages that will become better apparent hereinafter, are achieved by providing a container for metallic scrap, particularly for safely storing and transporting scrap of titanium and alloys thereof, comprising an external container body and a lid, characterized in that said external container body can be closed hermetically by means of said lid, defining and delimiting a vacuum chamber, and in that it comprises a vacuum pump, which is adapted to create vacuum in said vacuum chamber.

### BRIEF DESCRIPTION OF THE DRAWINGS

Further characteristics and advantages of the disclosure will become better apparent from the description of a preferred but not exclusive embodiment of the container for metallic scrap, particularly for safely storing and transporting scrap of titanium and alloys thereof, according to the disclosure, illustrated by way of non-limiting example with the aid of the accompanying drawings, wherein:

FIG. 1 is an exploded perspective view of an embodiment of the container for metallic scrap, particularly for safely storing and transporting scrap of titanium and alloys thereof, according to the disclosure;

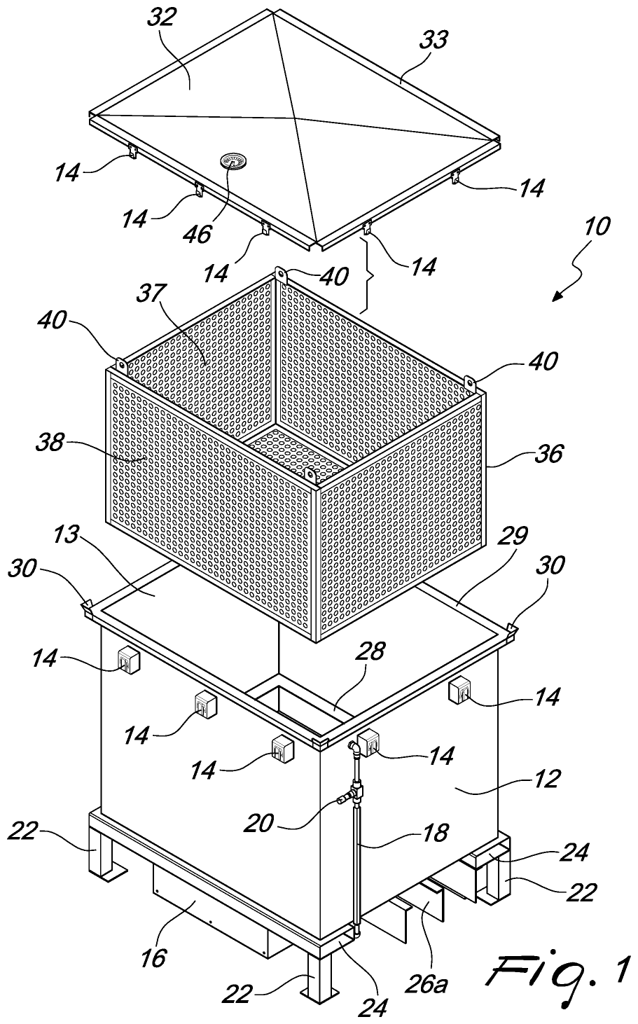

FIG. 2 is a front elevation view of the embodiment of the container for metallic scrap, particularly for safely storing and transporting scrap of titanium and alloys thereof, according to the disclosure, shown in FIG. 1;

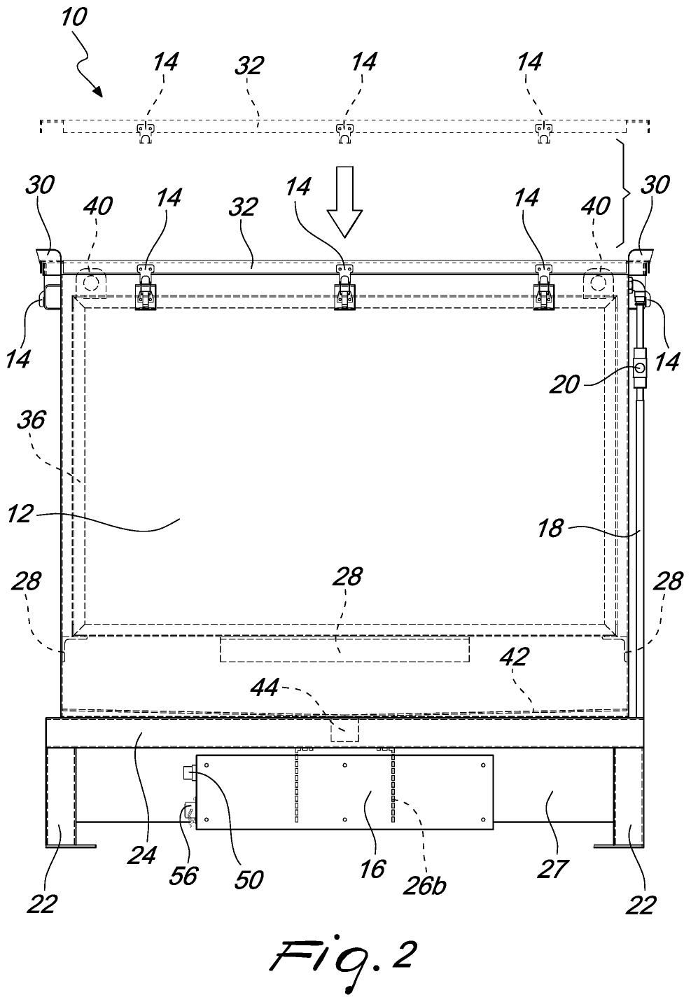

FIG. 3 is a cutout lateral elevation view of the embodiment of the container for metallic scrap, particularly for safely storing and transporting scrap of titanium and alloys thereof, according to the disclosure, shown in FIG. 1;

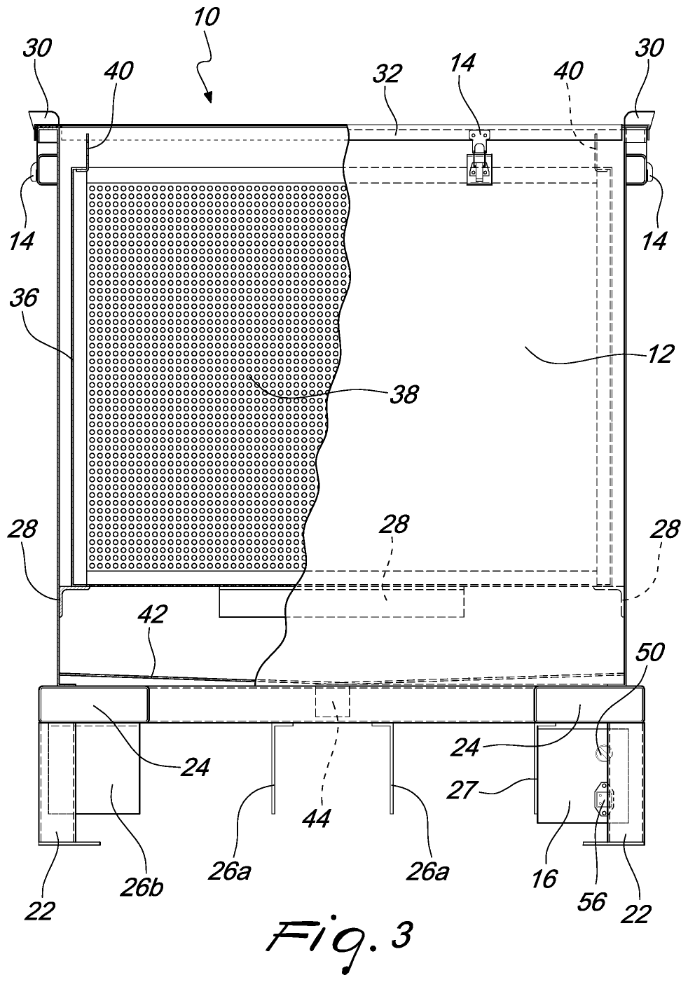

FIGS. 4a and 4b are a first detail view and a second detail view of the embodiment of the container for metallic scrap, particularly for safely storing and transporting scrap of titanium and alloys thereof, according to the disclosure, shown in FIG. 3;

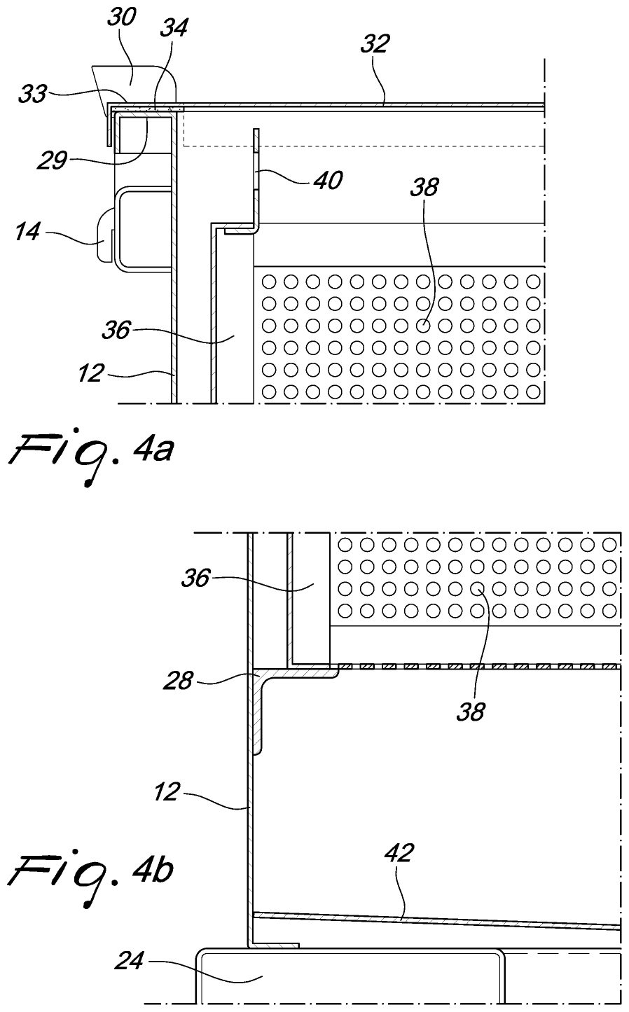

FIG. 5 is a block diagram that shows the vacuum pump system of an embodiment of the container for metallic scrap, particularly for safely storing and transporting scrap of titanium and alloys thereof, according to the disclosure; and

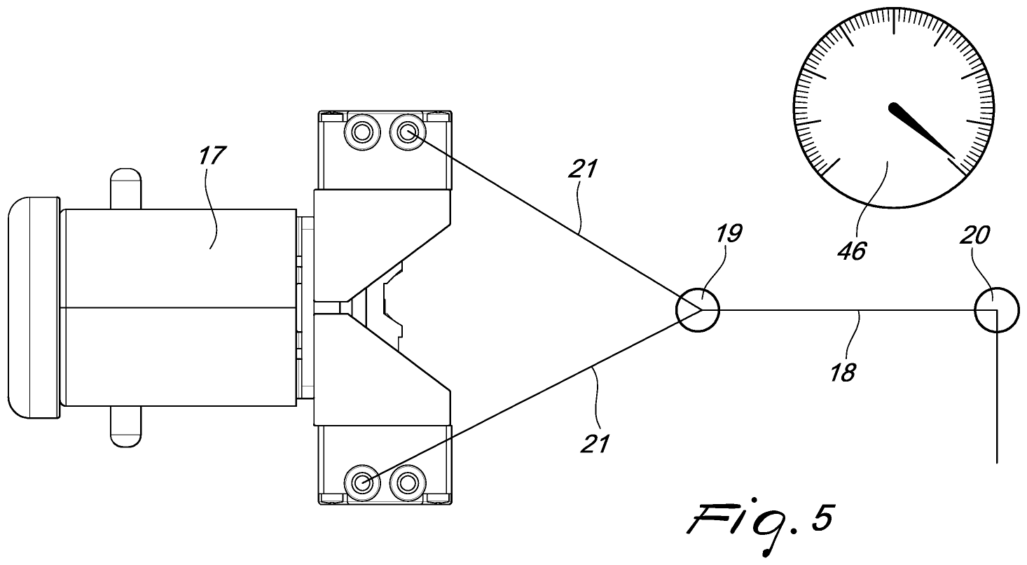

FIG. 6 is a block diagram of the electrical system of an embodiment of the container for metallic scrap, particularly for safely storing and transporting scrap of titanium and alloys thereof, according to the disclosure.

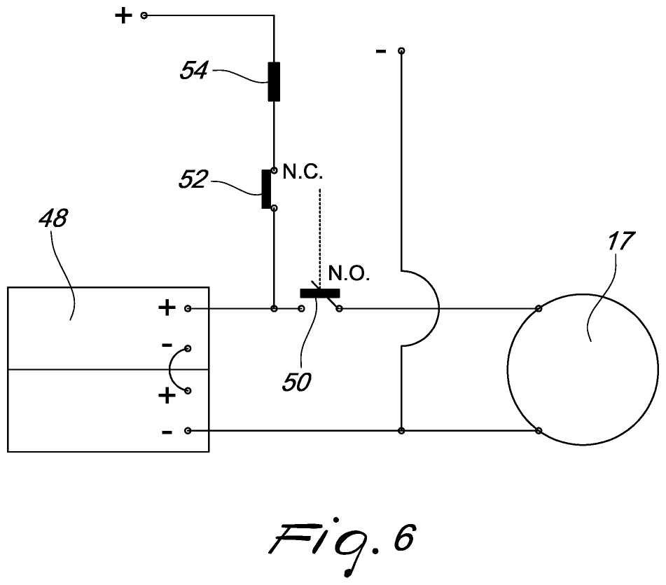

### DETAILED DESCRIPTION OF THE DRAWINGS

With reference to the cited figures, the container for metallic scrap, particularly for safely storing and transporting scrap of titanium and alloys thereof, according to the disclosure, generally designated by the reference numeral 10, substantially comprises an external container body 12, a vacuum pump 17, a perforated internal container body 36, and a lid 32. The external container body 12 can be closed hermetically by means of the lid 32, forming and delimiting a vacuum chamber.

The external container body, or outer shell, 12 is preferably provided by means of carbon steel plates of appropriate thickness, for example comprised between 1.5 and 2 millimeters, mutually rigidly coupled by means of welds.

The external container body 12 preferably has the shape of a right parallelepiped and for example its volume can be comprised between 0.8 and 1.2 cubic meters. The external container body 12 comprises an opening 13 at its upper face, this opening 13 being adapted to allow access to the inside of the external container body 12 on the part of the perforated internal container body 36.

The external container body 12 comprises coupling means 14, preferably a plurality of adjustable lever-based closure devices, which are adapted to couple the lid 32 to the external container body 12, consequently blocking the opening 13 of the latter. In particular, the external container body 12 comprises a first portion of the coupling means 14. The coupling means 14 are preferably arranged proximate to the rim 29 of the external container body 12.

The external container body 12 comprises a hopper-like bottom 42, at the vertex of which there is a discharge hole. Means 44 for discharging cooling liquid, such as for example a 1.5-inch ball valve, are associated with the discharge hole of the hopper-like bottom 42 and can be accessed from the outside by an operator.

The external container body 12 comprises internally at least one supporting profile 28, preferably of the angular type, which is preferably arranged proximate to the hopper-like bottom 42. The perforated internal container body 36 rests on the at least one supporting profile 28, once the perforated internal container body 36 has been inserted within the external container body 12.

The external container body 12 comprises at least one lid guide 30, which is arranged externally along the rim 29 of the external container body 12. Preferably, the external container body 12 comprises a lid guide 30 at each corner of the rim 29 of the external container body 12. The lid 32 is blocked horizontally by the at least one lid guide 30, once the lid 32 has been arranged above the rim 29 of the external container body 12.

The vacuum pump 17, which is preferably powered electrically, is adapted to create vacuum inside the container 10, i.e., in the vacuum chamber that is defined and delimited by the external container body 12 and by the lid 32, by extracting the air comprised therein, for example at a pressure comprise between 100 and 300 mbar. The vacuum pump 17 is also adapted to restore the ambient or atmospheric pressure inside the container 10, by introducing air in the vacuum chamber.

This vacuum pump 17 is connected to a compressed air duct 18, preferably of the linear type and with 8×10 dimensions.

The compressed air duct 18 is adapted to connect the vacuum pump 17 to the inside of the container 10, i.e., to the vacuum chamber of the container 10. Advantageously, an adjustment valve 20 is comprised along the compressed air duct 18 and is adapted to adjust the air flow in output from or in input to the vacuum chamber.

In one embodiment of the container 10 for metallic scrap according to the disclosure, the vacuum pump 17 is of the membrane type, which comprises at least one intake connection and at least one delivery connection, with 20 W of power, and powered at 24 V DC.

In this case, the vacuum pump 17, in particular the corresponding intake and delivery connections, is connected to the compressed air duct 18 by means of a two-way connector 19: in output from the vacuum pump 17 there are two compressed air ducts 21, preferably of the linear type and with 6×8 dimensions, whereas after the two-way connector 19 there is the above mentioned compressed air duct 18.

The container 10 for metallic scrap according to the disclosure comprises furthermore an electrical system, which is adapted to control and supply the vacuum pump 17 with electric power. In one embodiment of the container 10 for metallic scrap according to the disclosure, this electrical system comprises at least one preferably rechargeable battery 48, for example a pair of rechargeable lead batteries, each at 12 V DC, a connector 56 for recharging the at least one battery 48, an N.O. (normally-open) switch 50, a normally-closed (N.C.) switch 52, and a fuse 54 which, in case of a short circuit, prevents damage to the vacuum pump 17.

Advantageously, the external container body 12 comprises in a downward region and laterally a protective casing 16, which is adapted to contain the vacuum pump 17 and the electrical system and is adapted to protect these elements against impacts of various kinds. The protective casing 16 is preferably made of carbon steel of appropriate thickness, for example equal to 5 millimeters.

The external container body 12 comprises in a downward region a plurality of supporting feet 22, preferably a supporting foot 22 at each lower corner of the external container body 12.

Advantageously, the external container body 12 comprises in a downward region at least one pair of fork guides 24, which are mutually parallel and are adapted to guide and accommodate inside them the forks of a forklift truck, and are therefore adapted to ensure the maneuverability of the container 10 during the movement step, protecting it against impacts with the forks of the forklift truck.

Advantageously, the external container body 12 comprises in a downward region a plurality of protective plates 26a and 26b, which are adapted to protect the discharge means 44 against impacts of various kinds, in particular against impacts with the forks of the forklift truck during the step of moving the container 10 for metallic scrap according to the disclosure.

Advantageously, the external container body 12 comprises in a downward region at least one protective plate 27, which is adapted to protect the protective casing 16 against impacts of various kinds, in particular against impacts with the forks of the forklift truck during the step of moving the container 10 for metallic scrap according to the disclosure.

The perforated internal container body, or internal cage, 36 is preferably provided by means of perforated carbon steel plates, which comprise on the surface a plurality of holes 38 for example having a circular shape and with a diameter comprised between 6 and 10 millimeters, these plates being mutually rigidly coupled by means of welds.

The perforated internal container body 36 preferably has the shape of a right parallelepiped and comprises an opening 37 at its upper face, this opening 37 being adapted to allow the collection of the scrap of a reactive metal, such as for example titanium chips, within the perforated internal container body 36.

The perforated internal container body 36 is adapted to contain the scrap of a reactive metal, such as for example titanium chips. By means of its plurality of holes 38, the perforated internal container body 36 is adapted to filter said scrap and to separate (solid-liquid separation) the cooling liquid comprised therein, which derives from the machining of the reactive metal. Typically, the cooling liquid comprises water.

The cooling liquid, by passing through the plurality of holes 38, falls onto the hopper-like bottom 42 of the external container body 12. The cooling liquid is then discharged via of the discharge means 44 before creating vacuum inside the container 10 by starting the vacuum pump 17.

As mentioned, the perforated internal container body 36 rests on the at least one supporting profile 28 of the external container body 12, once the perforated internal container body 36 is inserted within the external container body 12.

The perforated internal container body 36 comprises in an upward region a plurality of engagement eyes 40, preferably an engagement eye 40 at each upper corner of the perforated internal container body 36. The engagement eyes 40 are adapted to facilitate the grip of the perforated internal container body 36 during the steps of insertion in, or extraction from, the external container body 12.

The lid 32 is preferably provided by means of a carbon steel plate of appropriate thickness, for example comprised between 1.5 and 2 millimeters.

The lid 32 is arranged above the rim 29 of the external container body 12. The lid 32 comprises sealing means 34, such as for example a gasket or a continuous strip of sponge, which are arranged along the lower face of the edge 33 of the lid 32.

In particular, the sealing means 34 are extended along the contact surface between the lid 32 and the external container body 12, in particular between the lower face of the edge 33 of the lid 32 and the upper face of the rim 29 of the external container body 12, consequently ensuring maximum tightness.

The lid 32 comprises coupling means 14, preferably a plurality of closure of adjustable lever-based closure devices, which are adapted to couple the lid 32 to the external container body 12, consequently blocking the opening 13 of the latter. In particular, the lid 32 comprises a second portion of the coupling means 14. The coupling means 14 are preferably arranged along the edge 33 of the lid 32.

In one embodiment of the container 10 for metallic scrap according to the disclosure, the lid 32 is pivoted to the external container body 12 by virtue of coupling means 14 with variable adjustment, in order to allow adjustment of the hermetic closure of the container 10 depending on the compression of the sealing means 34.

The lid 32 is independent and has no fixed points of connection to the external container body 12 and therefore the lid 32 does not occupy space during the steps of insertion or extraction of the perforated internal container body 36 in or from the external container body 12.

The combined action of the coupling means 14 and of the sealing means 34 allows to isolate hermetically the vacuum chamber, preventing the passage of any fluid, in particular of air, and to create vacuum inside the container 10.

Advantageously, the container 10 for metallic scrap according to the disclosure, in particular the lid 32, comprises a vacuum gauge 46, which is adapted to measure the residual pressure of the vacuum chamber that has been created inside the container 10.

In practice it has been found that the disclosure achieves fully the intended aims and advantages. In particular it has been shown that the container for metallic scrap, particularly for safely storing and transporting scrap of titanium and alloys thereof, thus conceived allows to overcome the qualitative limitations of the background art, since it allows correct storage of the scrap of a reactive metal, maximizing the safety level in the subsequent step of its transport, mainly land transport but also air transport and sea transport.

An advantage of the container for metallic scrap, particularly for safely storing and transporting scrap of titanium and alloys thereof, according to the present disclosure resides in that it prevents the triggering of combustion, which might cause a fire, or even an explosion, of the reactive metal stored and transported inside it.

Another advantage of the container for metallic scrap, particularly for safely storing and transporting scrap of titanium and alloys thereof, according to the present disclosure resides in that it allows to minimize the exposure to air of the reactive metal, consequently reducing the contact of the reactive metal with the gases for which it has affinity, such as for example oxygen, nitrogen, hydrogen or mixtures thereof.

A further advantage of the container for metallic scrap, particularly for safely storing and transporting scrap of titanium and alloys thereof, according to the present disclosure resides in that it allows to facilitate the operations for storage of the reactive metal and to speed up the operations for loading said container before its transport.

Moreover, an advantage of the container for metallic scrap, particularly for safely storing and transporting scrap of titanium and alloys thereof, according to the present disclosure resides in that it allows good maneuverability, ensuring the integrity of all of its parts and protecting them against any impacts of various kinds which might compromise its operation.

Although the container for metallic scrap according to the disclosure has been conceived in particular for safely storing and transporting scrap of titanium and alloys thereof, it can in any case be used more generally for the safe storage and transport of metals having a high reactivity when hot with oxygen, nitrogen or hydrogen present in the air, i.e., of all metals that have a risk of fire or even explosion if heated and placed in contact with the air of the surrounding environment. In addition to the already cited titanium and alloys thereof, other examples of reactive material are magnesium (symbol Mg) and alloys thereof, and zirconium (symbol Zr) and alloys thereof.

The disclosure thus conceived is susceptible of numerous modifications and variations, all of which are within the scope of the inventive concept. All the details may furthermore be replaced with other technically equivalent elements.

In practice, the materials used, so long as they are compatible with the specific use, as well as the contingent shapes and dimensions, may be any according to the requirements and the state of the art.

1. A container for metallic scrap, comprising: an external container body and a lid, wherein said external container body can be closed hermetically by means of said lid, defining and delimiting a vacuum chamber, and said container further comprising a vacuum pump, configured to create vacuum in said vacuum chamber.

2. The container for metallic scrap according to claim 1, further comprising a perforated internal container body, which comprises a plurality of holes, and is adapted to filter said scrap and to separate a cooling liquid, and in that said external container body comprises a hopper-like bottom, with the vertex of which means for discharging said cooling liquid are associated.

3. The container for metallic scrap according to claim 1, wherein said lid comprises sealing means arranged along the lower face of the edge of said lid.

4. The container for metallic scrap according to claim 1, wherein said external container body and said lid comprise coupling means, configured to couple said lid to said external container body.

5. The container for metallic scrap according to claim 1, wherein said vacuum pump is connected to a compressed air duct, said compressed air duct being adapted to connect said vacuum pump to said vacuum chamber.

6. The container for metallic scrap according to claim 5, wherein said compressed air duct comprises an adjustment valve, configured to adjust the air flow in output from, or in input to, said vacuum chamber.

7. The container for metallic scrap according to claim 1, wherein said external container body comprises a protective casing, configured to contain said vacuum pump and a corresponding electrical system, and is adapted to protect said vacuum pump and said electrical system against impacts of various kinds.

8. The container or metallic scrap according to claim 1, wherein said external container body comprises at least one pair of fork guides, which are mutually parallel and are adapted to guide and accommodate herein the forks of a forklift truck.

9. The container for metallic scrap according to claim 1, wherein said external container body comprises a plurality of protective plates are adapted to protect said discharge means against impacts of various kinds.

10. The container for metallic scrap according to claim 1, wherein said external container body comprises at least one protective plate, which is adapted to protect said protective casing against impacts of various kinds.

11. The container for metallic scrap according to claim 1, wherein said external container body comprises a plurality of supporting feet.

12. The container for metallic scrap according to claim 1, wherein said external container body comprises at least one supporting profile, on which said perforated internal container body rests.

13. The container for metallic scrap according to claim 1, wherein said external container body comprises at least one lid guide is arranged externally along the rim of said external container body and is adapted to block said lid horizontally.

14. The container for metallic scrap according to claim 1, wherein said perforated internal container body comprises in an upper region a plurality of engagement eyes adapted to facilitate the grip of said perforated internal container body.

15. The container for metallic scrap according to claim 1, wherein said container comprises a vacuum gauge, configured to measure the residual pressure of said vacuum chamber that has formed inside said container.
